(19) United States
(12) Patent Application Publication
(10) Pub. No.: US 2006/0083374 A1
(43) Pub. Date: Apr. 20, 2006

(54) Security systems for programmable logic controllers

(76) Inventors: Bruce Douglas Drake, Cary, NC (US); Joseph Richard Mall, Clayton, NC (US); Kartik Subramanian, Raleigh, NC (US); Nishant Bhatia, San Francisco, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/248,656

(22) Filed: Oct. 12, 2005

Related U.S. Application Data
(60) Provisional application No. 60/620,956, filed on Oct. 20, 2004.

(51) Int. Cl. H04N 7/167

(52) U.S. Cl. 380/203

(57) ABSTRACT

A security system encrypts the password on an operator interface terminal without storing the password and sends the encrypted password to a programmable logic controller, where the password is again encrypted. The multiple-encrypted password is stored on the programmable logic controller. Even if an unauthorized individual were able to see the multiple-encrypted password, it would be difficult for the unauthorized individual to deduce the original password from the multiple-encrypted password. Accesses and changes of parameters are tracked and reportable.

### CROSS-REFERENCE TO RELATED APPLICATION

This application claims the benefit of U.S. Provisional Application No. 60/620,956, filed on Oct. 20, 2004.

### FIELD OF THE INVENTION

The present invention relates generally to security, and more particularly, to the prevention of access to programmable logic controllers by unauthorized individuals.

### BACKGROUND OF THE INVENTION

The linguistic root of the word “manufacturing” means something created or mechanized and automated. FIG. 1 illustrates block diagrams of a manufacturing process to produce pharmaceutical drugs 106. An operator 102 monitors the processing of chemicals where the pharmaceutical drugs 106 are manufactured in discrete stages. The mechanization and the automation of these stages are typically controlled by one or more programmable logic controllers 108.

Each programmable logic controller 108 is a simple microprocessor with limited memory and limited input or output capacity. Because of the simple architecture, programmable logic controllers are a low cost solution for controlling complex manufacturing systems, such as the system 100 for producing pharmaceutical drugs 106. As they are microprocessors—albeit much more simple in architecture—the programmable logic controller 108 provides some computation abilities allowing for intricate control of complex manufacturing processes. Moreover, programmable logic controllers are typically reliable with response times that are suitable in manufacturing environments making them preferable to more complex microprocessor architecture, such as those used in personal computers.

Each stage of a manufacturing process is an investment of raw materials, labor, and machinery, which is worth hundreds if not millions of dollars. An unauthorized individual or a disgruntled employee can access an unsecured programmable logic controller to change manufacturing parameters and wreak havoc or contaminate the produced pharmaceutical drugs. To govern access, conventional password systems are typically implemented to force the operator 102 to enter a correct password in order to access the programmable logic controller 108 to change parameters or to view status of the stages of the manufacturing process. But passwords in these systems are readily visible to anyone who can directly connect to the programmable logic controller 108 with a laptop to look at the source code implementing password systems.

The most pernicious problem of all, however, is that unauthorized changes to the stages of manufacturing may cause the final product, such as pharmaceutical drugs 106, to be unfit for sale, ruining millions of dollars in investment. The Federal Drug Administration (FDA) in the United States has promulgated regulations requiring manufacturers of pharmaceutical drugs to define their manufacturing process, the parameters involved, and the steps to process raw materials, such as the chemicals 104, to the final products, such as the pharmaceutical drugs 106. If an unauthorized change occurs, the produced pharmaceutical drugs 106 may be outside of the scope of the manufacturing license permitted by the FDA. Even if the changes made are within the scope of the manufacturing license from the FDA, the burden is high to show that the changes did not cause the produced pharmaceutical drugs 106 to deviate in a way that may harm consumers.

Without a solution to keep the stages of manufacturing processes secured from unauthorized individuals, it may eventually cause organizations, such as the FDA, to no longer trust the system 100 to provide pharmaceutical drugs as approved by an FDA license. As a result, investment in the usage of the system 100 will diminish in the marketplace. Thus, there is a need for a system and method for administering and verifying passwords while avoiding or reducing the foregoing and other problems associated with existing systems.

### SUMMARY OF THE INVENTION

In accordance with this invention, a system, method, and computer-readable medium for controlling manufacturing processes is provided. The system form of the invention includes a system for controlling access to automated processes that includes an operator interface terminal on which an operator interface terminal password encryption piece of software is executing. The operator interface terminal password encryption piece of software encrypts a password entered into the operator interface terminal to form a first encrypted password. The system further includes a programmable logic controller on which a programmable logic controller password encryption piece of software is executing. The programmable logic controller password encryption piece of software encrypts the first encrypted password to form a second encrypted password. The programmable logic controller allows access to control the manufacturing processes if the second encrypted password matches a stored password on the programmable logic controller.

In accordance with further aspects of this invention, the method form of the invention includes a computer-implemented method, which comprises receiving a password by an operator interface terminal and encrypting the password by an operator interface terminal password encryption piece of software to produce a first encrypted password. The method further comprises receiving the first encrypted password by a programmable logic controller and encrypting the first encrypted password by a programmable logic controller password encryption piece of software to produce a second encrypted password.

In accordance with further aspects of this invention, the computer-readable medium form of the invention includes A computer-readable medium having computer-executable instructions stored thereon that implements a method, which comprises receiving a password by an operator interface terminal and encrypting the password by an operator interface terminal password encryption piece of software to produce a first encrypted password. The method further comprises receiving the first encrypted password by a programmable logic controller and encrypting the first encrypted password by a programmable logic controller password encryption piece of software to produce a second encrypted password.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating the use of programmable logic controllers to control stages in the manufacturing of pharmaceutical drugs;

FIG. 2 is a block diagram illustrating an exemplary security system for programmable logic controllers for preventing access by unauthorized individuals;

FIG. 3A is a textual diagram illustrating a password to be encrypted by an operator interface terminal, in accordance with one embodiment of the present invention;

FIG. 3B is a textual diagram illustrating another password to be encrypted by an operator interface terminal, in accordance with one embodiment of the present invention;

FIG. 3C is a textual diagram illustrating an encrypted password in binary form that will be further encrypted, in accordance with one embodiment of the present invention;

FIG. 3D is a textual diagram that illustrates the multiple encryptions of a password that is stored on a programmable logic controller, in accordance with one embodiment of the present invention; and

FIGS. 4A-4I are process diagrams illustrating methods for managing passwords as well as for verifying passwords, in accordance with one embodiment of the present invention.

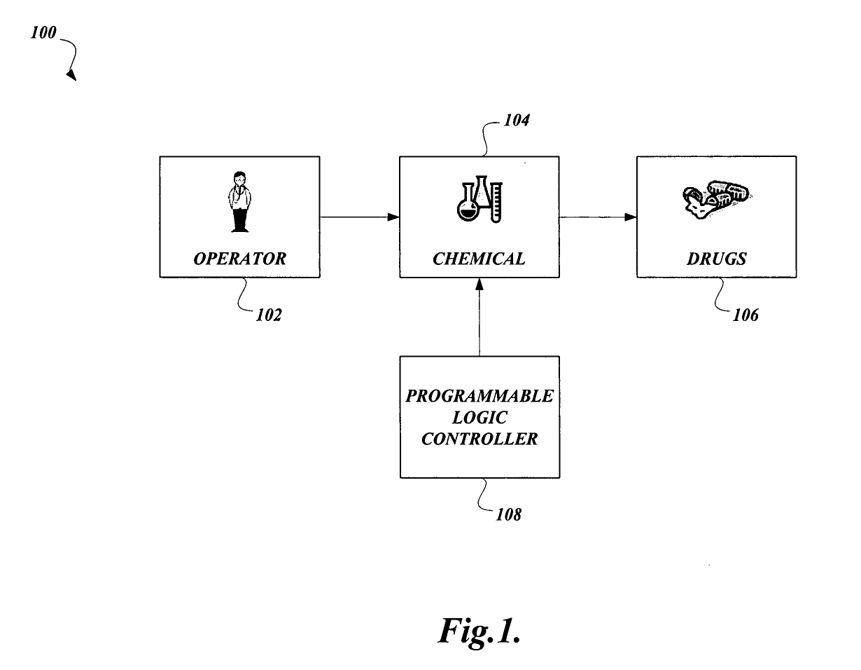

### DETAILED DESCRIPTION OF THE PREFERRED EMBODIMENT

The security system provided by various embodiments of the present invention encrypts the password on an operator interface terminal without storing the password and sends the encrypted password to a programmable logic controller, where the password is again encrypted. The multiple-encrypted password is stored on the programmable logic controller. Even if an unauthorized individual were able to see the multiple-encrypted password, it would be difficult for the unauthorized individual to deduce the original password from the multiple-encrypted password. Moreover, various embodiments of the present invention allow accesses and changes of parameters to be tracked and reportable.

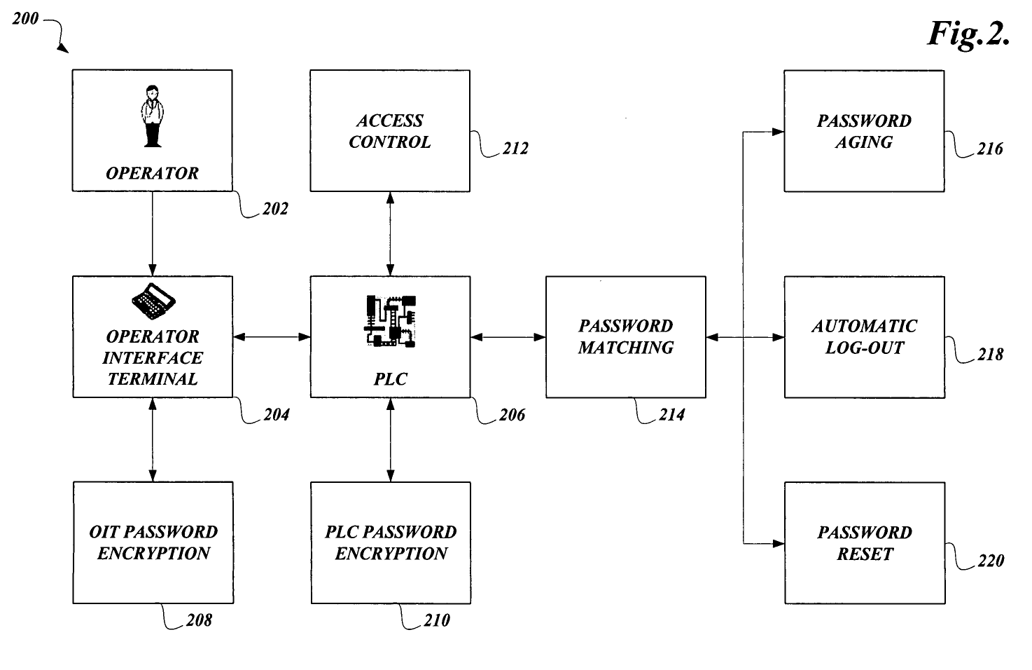

FIG. 2A illustrates a system 200 in which an operator 202, such as a worker in a manufacturing facility for producing pharmaceutical drugs, uses an operator interface terminal 204 to send input to the programmable logic controller 206 as well as to receive output from the programmable logic controller 206. The operator interface terminal 204 includes a keyboard that conveys information from the operator 202 to the programmable logic controller 206. A flat-panel display, which is usually an LCD-based or a gas plasma-based display, acts as a visual output device for displaying user interface screens that interact with the programmable logic controller 206 to change parameters or to display status information.

Typically, the operator interface terminal 204 is itself controlled by a simple microprocessor running various programs, such as a password encryption program 208, which executes on the operator interface terminal 204. The programmable logic controller 206 is a simple computer with limited memory and requires minimal power to run. The programmable logic controller 206 is a preferred choice for controlling manufacturing processes. There are many reasons for using programmable logic controllers. For instance, programmable logic controllers are typically lower in cost for regulating complex manufacturing systems as compared to the use of modern PC microprocessors. The programmable logic controller 206 also allows limited computational abilities to permit better complex control than the use of ordinary relays to make logic control decisions. Because of its simple architecture, the programmable logic controllers are typically reliable with responsive behaviors, which is desirable for regulating industrial processes.

The operator interface terminal 204 displays user interface screens to the operator 202, allowing the operator 202 to provide input, such as changing parameters. Additionally, user interface screens can be made available by the operator interface terminal 204 to display output or the status of the manufacturing process being controlled by the programmable logic controller 206. These user interface screens can be selectively displayed to the operator 202, depending on the level of access of the operator 202. An access control module 212 communicates with the programmable logic controller 206 so as to restrict or permit user interface screens that are accessible by the operator 202. These restrictions or permissions are dependent on the user identification and the password provided by the operator 202 to the operator interface terminal 204 at the time of login. When the operator 202 has provided the user identifier and the associated password via the operator interface terminal 204, the operator interface terminal password encryption module 208 encrypts the password using a suitable encryption technique. Any suitable encryption technique can be used as long as the encryption technique is operable on a device with limited memory and processing power such as the operator interface terminal 204. (Where there is no opportunity for observation of the first password, mere translation of the data to a form readable by the programmable logic controller may be sufficient for the first encryption.)

Once the password has been encrypted by the operator interface terminal password encryption module 208, the encrypted password is communicated to the programmable logic controller 206. Preferably, the operator interface terminal password encryption component 208 resides on the operator interface terminal 204. The programmable logic controller 206 includes a programmable logic controller password encryption component 210, which is preferably a separate password encryption module from the operator interface terminal password encryption module 208. The programmable logic controller password encryption module 210 resides on the programmable logic controller 206. When the programmable logic controller password encryption module 210 has received the encrypted password from the operator interface terminal 204, it further encrypts the encrypted password via any suitable encryption technique or a combination of encryption techniques that are appropriate for the limited memory and processing power of the programmable logic controller 206. The resultant multiple-encrypted password is stored in the memory of the programmable logic controller 206.

A password matching module 214 executing on the programmable logic controller 206 determines whether the password provided by the operator 202, in connection with the user identifier, matches the multiple-encrypted password stored on the programmable logic controller 206. If the password does not match, the password matching component 214 communicates with the access control module 212 to disallow the presentation of user interface screens to the operator 202. If the password matches, the password matching module 214 allows the operator 202 to access selected user interface screens available to the operator 202 based on his user identifier.

A password aging component 216 is executable on the programmable logic controller 206. The password aging component 216 monitors passwords stored by the programmable logic controller 206 and determines whether one or more of these passwords has aged beyond a certain time period threshold. If a password has aged beyond the threshold, the password aging component 216 compels the operator 202 to enter a new password to supplant the old password before further access to user interface screens is granted. One suitable technique of aging a password is to stamp each password stored by the programmable logic controller 206 with a date and a time from which the age of the password can be determined.

The system 200 also includes an automatic logout component 218, which is capable of being executed on the programmable logic controller 206. The automatic logout component 218 terminates the access by the operator 202 to the programmable logic controller 206 via the operator interface terminal 204 when a certain period of inactivity has expired. An administrator of the security system of the programmable logic controller 206 can invoke a password reset module 220 to reset any password and assign a new password. The password reset component 220 is useful for cases where the operator 202 has forgotten his password to access the system 200.

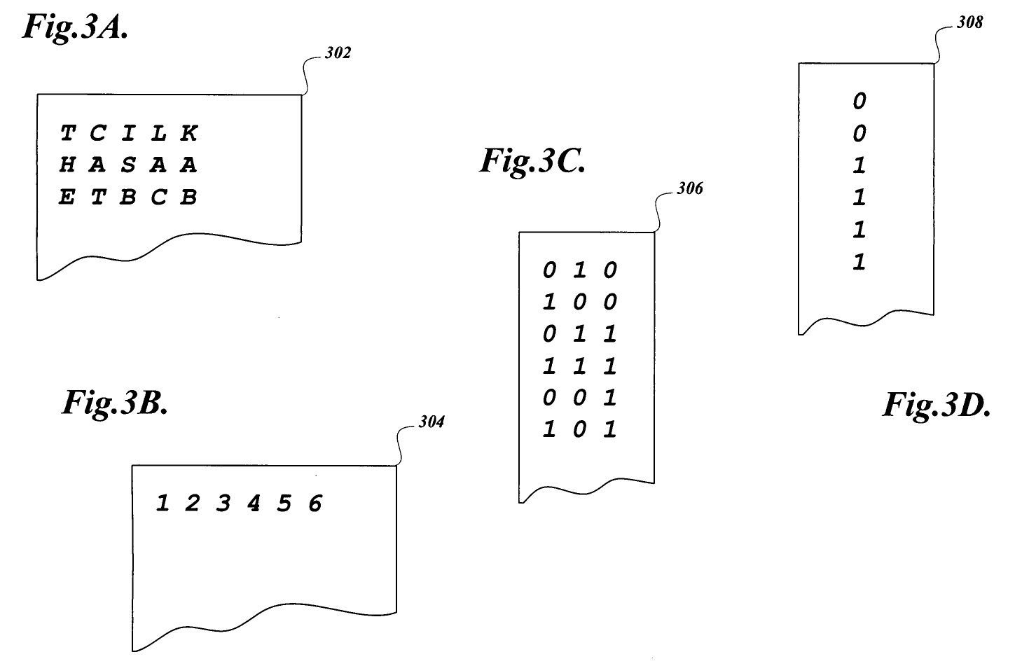

FIG. 3A illustrates a textual password that is encrypted in one suitable encryption technique. The password is “THE CAT IS BLACK.” The encryption orients the pass phrase in a matrix 302, such that the word “THE” occupies the first column of the matrix 302. The word “CAT” occupies the second column of the matrix 302. The verb “IS” and the first letter “B” of the word “BLACK” occupies the third column of the matrix 302. In the fourth column of the matrix 302, a portion “LAC” of the word “BLACK” is contained. The fifth column includes the last letter “K” of the word “BLACK.” The fifth column also includes some filler letters “AB.”

The operator interface terminal 204 then transmits portions of the matrix 302 to the programmable logic controller 206 by sending one row of the matrix 302 at a time. For example, in the first communication, the operator interface terminal 204 sends “TCILK”, which is the first row. In the second communication with the programmable logic controller 206, the operator interface terminal 204 sends “HASAA”, which is the second row of the matrix 302. In the last communication with the programmable logic controller 206, the third row “ETBCB” is sent by the operator interface terminal 204.

FIG. 3B illustrates a numerical password 304, which can be encrypted and sent to the programmable logic controller 206. Prior to sending, the operator interface terminal 204 applies a suitable encryption technique. One suitable encryption technique includes taking a group of numbers, such as “12,” and applying a mathematical expression to the number. For example, the number “12” can be multiplied by a number “2” and the product added to the number 4, rendering the sum to be number “28”. The number “28” is then sent by the operator interface terminal 204 to the programmable logic controller 206. The encryption of both the password represented by the matrix 302 and the password 304 is carried out by the operator interface terminal password encryption component 208.

When passwords 302, 304 have been encrypted and sent to the programmable logic controller 206, preferably, each portion of the password is transformed into a binary number. FIG. 3C illustrates three binary numbers 306 presented vertically. For example, each portion of the password represented by the matrix 302, such as “TCILK,” can be transformed into a binary number by summing the ASCII equivalent of each letter in the portion. As another example, each portion of the pass phrase 304 that has been encrypted can simply be transformed into its binary equivalent. FIG. 3C shows three binary numbers 306 presented vertically. The first number is “010101 ”. The second binary number is “101100”. The third binary number is “001111”. The binary numbers 306 can be further encrypted by the programmable logic controller password encryption component 210.

One suitable encryption technique is for the programmable logic controller password encryption component 210 to apply logical operators to each digit of the three binary numbers 306. For example, one suitable encryption technique includes ANDing the first two binary digits and ORing the resultant binary digit from the first logical operation to the third binary digit. Using such logical operations, the three binary numbers 306 result in another binary number 308. See FIG. 3D. Binary number 308 is “001111”. The binary number 308 is a multiple-encrypted password and is stored on the programmable logic controller 206.

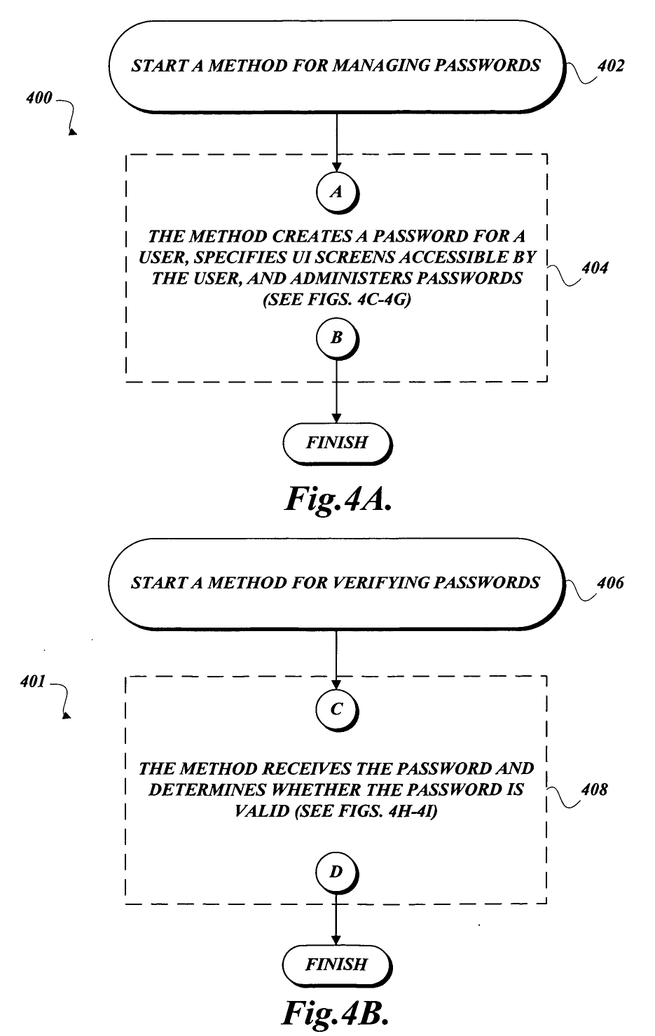

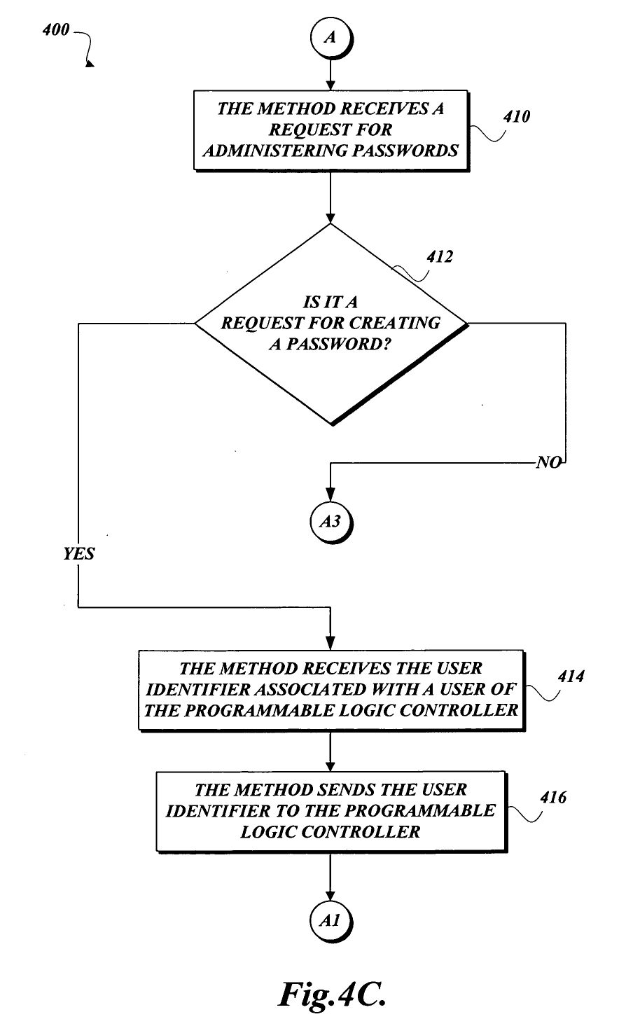

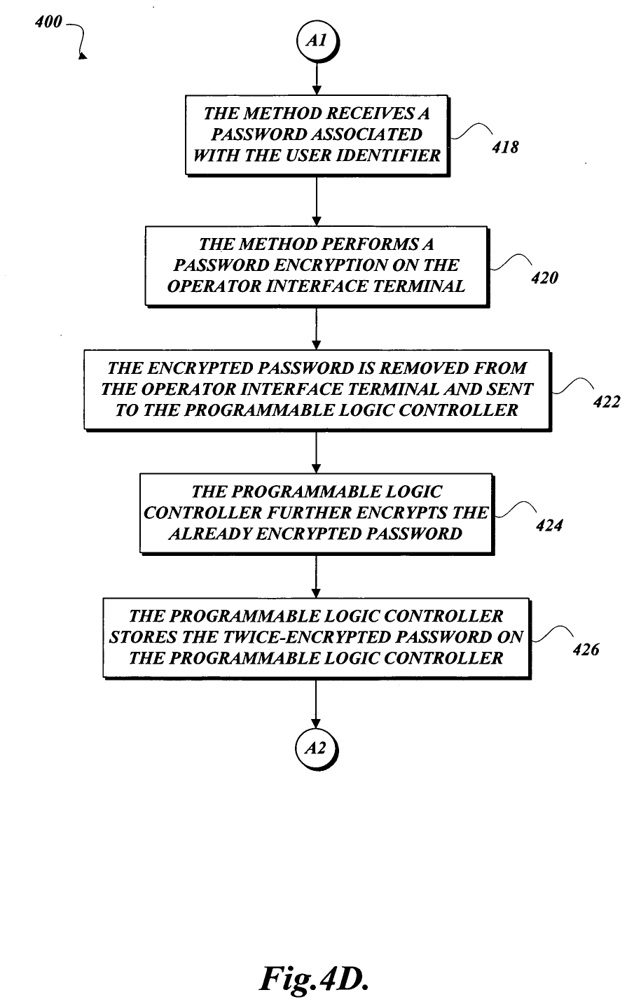

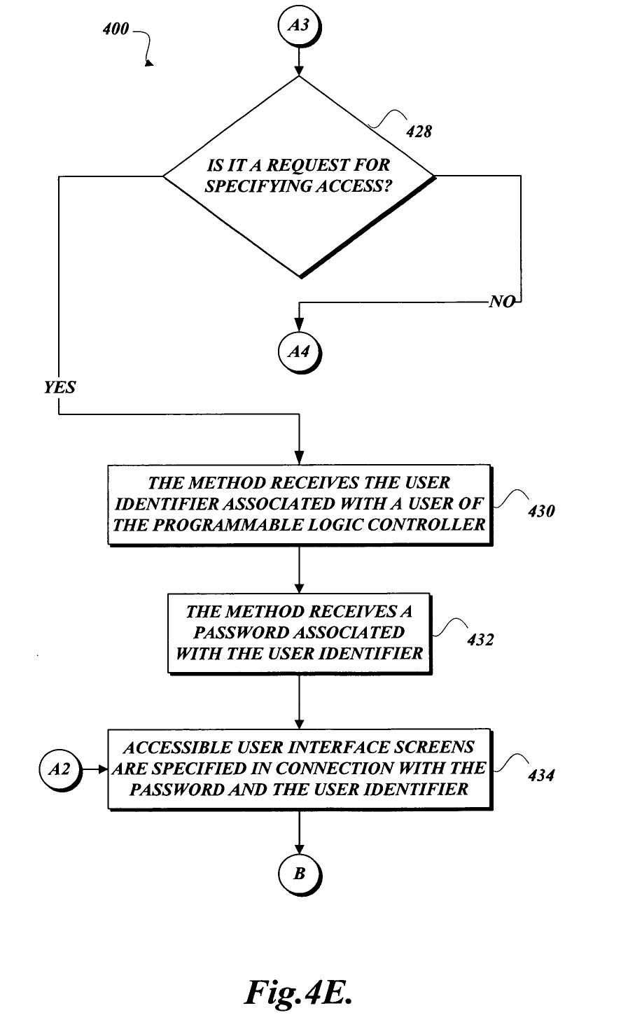

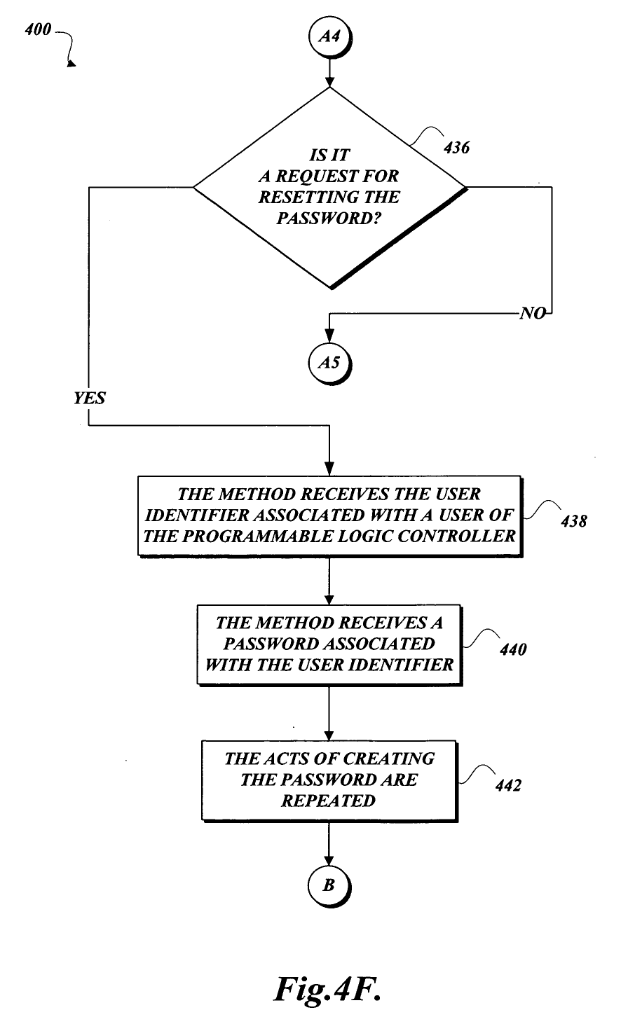

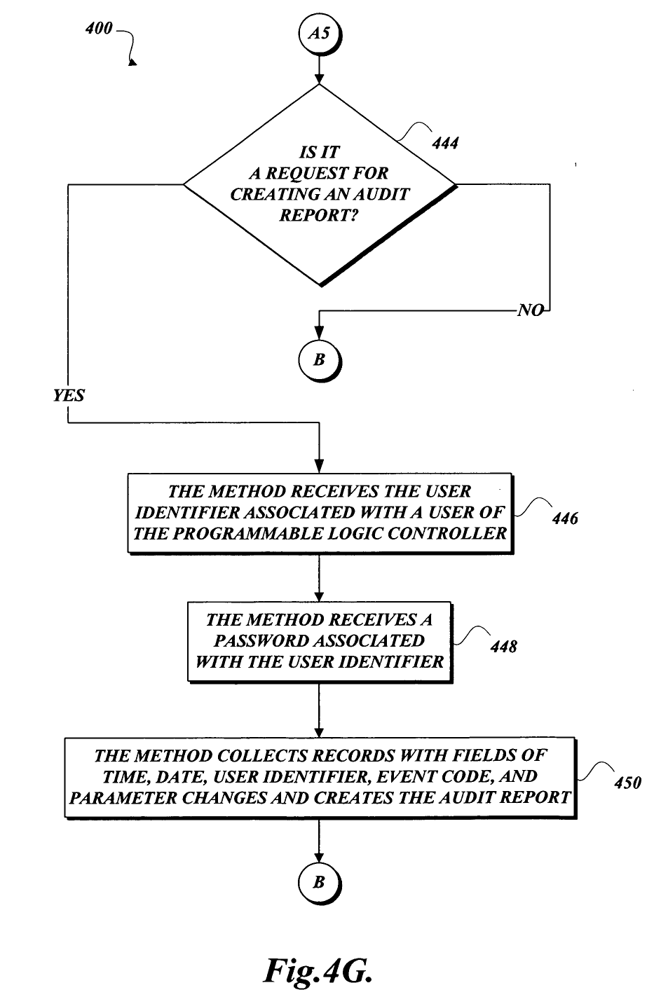

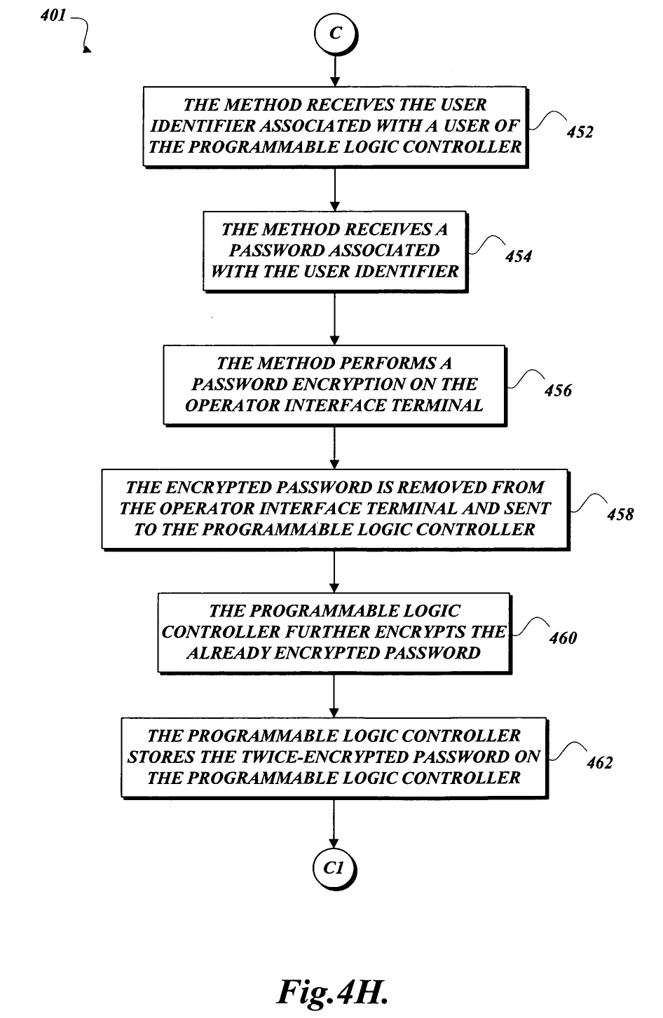

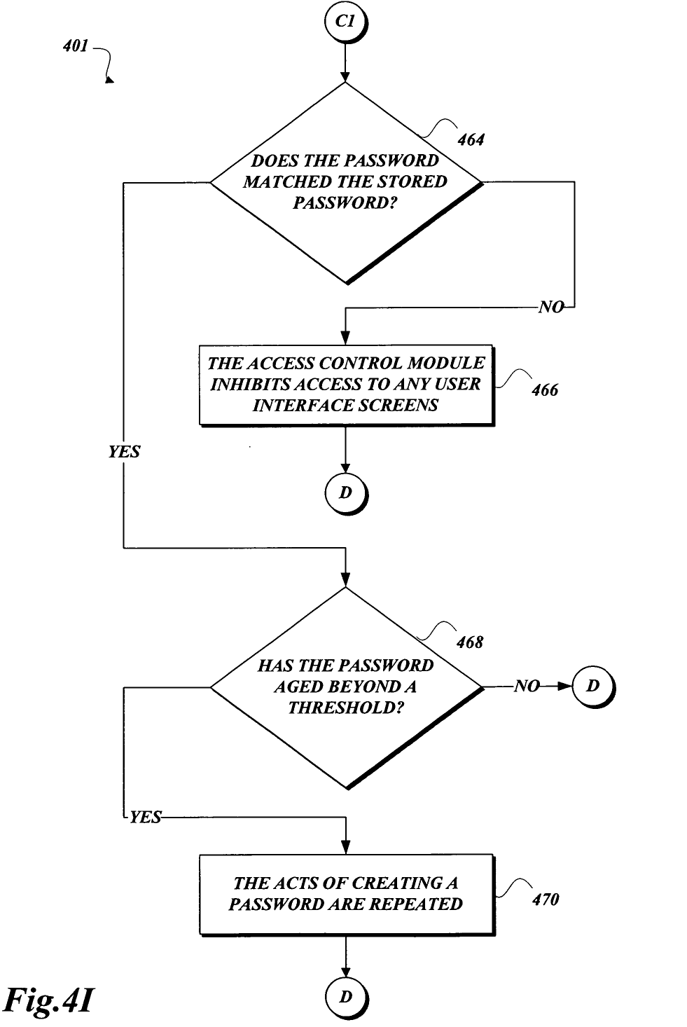

FIGS. 4A-4I illustrate methods 400, 401 for managing and verifying passwords. For clarity purposes, the following description of methods 400, 401 makes references to various elements illustrated in connection with the operator interface terminal 204, the operator interface terminal password encryption module 208, the programmable logic controller 206, the programmable logic controller password encryption module 210, the access control component 212, the password matching component 214, the password aging component 216, the password reset component 220 (FIG. 2), and textual diagrams of FIGS. 3A-3D. From a start block 402, the method 400 proceeds to a set of method steps 404, defined between a continuation terminal (“terminal A”) and an exit terminal (“terminal B”). The set of method steps 404 describes the creation of a password for a user, specifying user interface screens accessible by the user, and administering passwords.

From terminal A (FIG. 4C), the method 400 proceeds to block 410 where the method receives a request for administering passwords. Next at decision block 412, a test is made to determine whether the request is for creating a password. If the answer to the test at decision block 412 is NO, the method continues to another continuation terminal (“terminal A3”). If the answer to the test at decision block 412 is YES, the method 400 continues to block 414 where the method receives the user identifier associated with a user or the operator 202 of the programmable logic controller 206. At block 416, the method 400 sends the user identifier to the programmable logic controller 206. The method 400 then continues at another continuation terminal (“terminal A1”).

From terminal A1 (FIG. 4D), the method 400 proceeds to block 418, where the method receives a password associated with the user identifier. The method performs a password encryption using the operator interface terminal password encryption component 208 that executes on the operator interface terminal 204. The encrypted password is then removed from the operator interface terminal 204 and sent to the programmable logic controller 206. See block 422. At block 424, the programmable logic controller 206 further encrypts the already encrypted password from the operator interface terminal 204. At block 426, the programmable logic controller 206 stores the multiple-encrypted password in its memory. The method 400 then continues at another continuation terminal (“terminal A2”). From terminal A2 (FIG. 4E), the method 400 proceeds to block 434 where the accessible user interface screens are specified in connection with the password and the user identifier. The method 400 then continues to the exit terminal B and terminates execution.

From terminal A3 (FIG. 4E), the method 400 proceeds to decision block 428 where a test is made to determine whether the request is for specifying access. If the answer to the test at decision block 428 is NO, the method 400 proceeds to another continuation terminal (“terminal A4”). If the answer to the test at decision block 428 is YES, the method 400 continues to block 430 where the method receives the user identifier associated with a user of the programmable logic controller 206. The method also receives a password associated with the user identifier. See block 432. The method 400 then allows the user to access the access control module 212 and allows the user to specify user interface screens in connection with the password and the user identifier. See block 434. The method 400 then exits through terminal B and terminates execution.

From terminal A4 (FIG. 4F), the method 400 proceeds to decision block 436 where a test is made to determine whether the request has been made for resetting the password. If the answer to the test at decision block 436 is NO, the method 400 proceeds to another continuation terminal (“terminal A5”). Otherwise, the answer to the test at decision block 436 is YES, and the method 400 receives the user identifier associated with a user of the programmable logic controller 206. See block 438. Next, at block 440, the method receives a password associated with the user identifier. The acts of creating the password, as described in the above-identified processing steps 420-426 and 434, are repeated. The method 400 then enters exit terminal B and terminates execution.

From terminal A5 (FIG. 4G), the method 400 proceeds to decision block 444 where a test is made to determine whether the request is a request for creating an audit report. If the answer to the test at decision block 444 is NO, the method 400 proceeds to exit terminal B and terminates execution. If the answer to the test at decision block 444 is YES, the method 400 proceeds to block 446 where the method receives the user identifier associated with a user of the programmable logic controller 206. The method also receives a password associated with a user identifier. See block 448. The method then collects records of information with fields of time, date, user identifier, and event code, as well as parameter changes made. There can be many suitable event codes that are customizable by the administrator of passwords. One example of an event code includes a login event. See block 450. The method 400 then creates the audit report. The method 400 proceeds to the exit terminal B and terminates execution.

From a start block 406, the method 401 proceeds to a set of method steps 408, defined between a continuation terminal (“terminal C”) and an exit terminal (“terminal D”). The set of method steps 408 describes the act of receiving the password and determining whether the password is valid.

From terminal C (FIG. 4H), the method 401 proceeds to block 452 where the method receives the user identifier associated with a user of the programmable logic controller 206. At block 454, the method receives a password associated with the user identifier. The method performs a password encryption on the operator interface terminal 204. See block 456. The encrypted password is then removed from the operator interface terminal 204 and sent to the programmable logic controller 206. See block 458. At block 460, the programmable logic controller 206 further encrypts the already encrypted password. Next, at block 462, the programmable logic controller 206 stores the twice-encrypted password on the programmable logic controller 206. The method then continues at another continuation terminal (“terminal C1”).

From terminal C1 (FIG. 4I), the method 401 proceeds to decision block 464 where a test is made to determine whether the password matches the stored password. If the answer to the test at decision block 464 is NO, the access control module 212 inhibits the operator 202 from accessing any user interface screens displayable by the operator interface terminal 204. See block 466. The method 401 then continues to exit terminal D and terminates execution. If the answer to the test at decision block 464 is YES, the method 401 continues to another decision block 468 where a test is performed to determine whether the password has aged beyond a threshold. If the answer to the test at decision block 468 is NO, the method 401 continues to the exit terminal D and terminates execution. (At this point, the user is logged on and allowed permitted access, which may be specified based on individual user identification or various user identifications may be assigned to a group with common access privileges.) If, otherwise, the answer to the test at decision block 468 is YES, the method proceeds to block 470 where the acts of creating a password described above in connection with steps 414-426 and 434 are repeated. The method 401 then continues to exit terminal D and terminates execution.

While the preferred embodiment of the invention has been illustrated and described in connection with the production of pharmaceutical drugs, it will be appreciated that various changes can be made therein without departing from the spirit and scope of the invention. For example, the security system of various embodiments of the present invention can be used in the microelectronic field, semiconductor field, biotechnology field, and any field that requires control of an automated process, such as a manufacturing process.

The embodiments of the invention in which an exclusive property or privilege is claimed are defined as follows:

1. A system of controlling access to automated processes, comprising:
a programmable logic controller on which a programmable logic controller password encryption piece of software is executing, the programmable logic controller password encryption piece of software encrypting a first encrypted password to form a second encrypted password, the programmable logic controller allowing access to control the manufacturing processes if the second encrypted password matches a stored password on the programmable logic controller.

2. The system of claim 1, further including an operator interface terminal on which an operator interface terminal password encryption piece of software is executing, the operator interface terminal password encryption piece of software encrypting a password entered into the operator interface terminal to form the first encrypted password.

3. The system of claim 1, further including an access control piece of software for specifying accessible user interface screens, the access control piece of software deciding whether or not to process instructions from the accessible user interface screens based on an identification of a user.

4. The system of claim 1, further including a password matching piece of software for determining whether the second encrypted password matches the stored password on the programmable logic controller.

5. The system of claim 1, further including a password aging piece of software for determining whether the stored password has aged beyond a threshold so as to require that the stored password be changed.

6. The system of claim 1, further including an automatic logout piece of software that automatically logs out a user after a period of inactivity.

7. The system of claim 1, further including a piece of software for producing audit reports that include multiple fields, the multiple fields including a date, a time, a user identifier, and an event code.

8. A computer-implemented method, comprising:
receiving a password by an operator interface terminal and encrypting the password by an operator interface terminal password encryption piece of software to produce a first encrypted password; and
receiving the first encrypted password by a programmable logic controller and encrypting the first encrypted password by a programmable logic controller password encryption piece of software to produce a second encrypted password.

9. The method of claim 8, further comprising determining whether the second encrypted password matches a stored password.

10. The method of claim 9, further comprising permitting or denying access to a set of user interface screens to control the programmable logic controller depending on whether the second encrypted password matches the stored password.

11. The method of claim 10, further comprising determining whether the stored password has aged beyond a threshold and requiring the stored password to be changed when the stored password has aged beyond the threshold.

12. The method of claim 8, further comprising automatically logging out a user after a period of inactivity.

13. The method of claim 8, further comprising resetting the password by an administrator.

14. The method of claim 8, further comprising producing an audit report of records, each record including a date, time, a user identifier, and an event code.

15. A computer-readable medium having computer-executable instructions stored thereon that implements a method, the method comprising:
receiving a password by an operator interface terminal and encrypting the password by an operator interface terminal password encryption piece of software to produce a first encrypted password; and
receiving the first encrypted password by a programmable logic controller and encrypting the first encrypted password by a programmable logic controller password encryption piece of software to produce a second encrypted password.

16. The method of claim 15, further comprising determining whether the second encrypted password matches a stored password.

17. The method of claim 16, further comprising permitting or denying access to a set of user interface screens to control the programmable logic controller depending on whether the second encrypted password matches the stored password.

18. The method of claim 17, further comprising determining whether the stored password has aged beyond a threshold and requiring the stored password to be changed when the stored password has aged beyond the threshold.

19. The method of claim 15, further comprising automatically logging out a user when a period of inactivity has expired.

20. The method of claim 15, further comprising resetting the password by an administrator.

21. The method of claim 15, further comprising producing an audit report of records, each record including a date, time, a user identifier, and an event code.
